(19) United States
(12) Patent Application Publication
(10) Pub. No.: US 2025/0038997 A1
(43) Pub. Date: Jan. 30, 2025

(54) SYSTEMS AND METHODS TO AUTHENTICATE AND VERIFY SMART CONTRACTS

(71) Applicant: Melvin Hwang Chee Wong, Seoul (KR)

(72) Inventor: Melvin Hwang Chee Wong, Seoul (KR)

(21) Appl. No.: 18/675,208

(22) Filed: May 28, 2024

Related U.S. Application Data
(60) Provisional application No. 63/528,915, filed on Jul. 26, 2023.

(51) Int. Cl. H04L 9/32

(52) U.S. Cl. CPC H04L 9/3268

(57) ABSTRACT

Methods and systems for authenticating and verifying smart contracts. One of the methods of authentication includes an entity: obtaining a digital certificate and a key pair; performing a key pair and a digital certificate ownership verification process; upon confirming that the entity owns the key pair and digital certificate, deploying a smart contract on a blockchain and storing the digital certificate and the public key on the smart contract. One of the methods of verification includes: reading a smart contract address, a public key and a digital certificate on a smart contract; reading a public key and/or private key entered by an entity; verifying that the entity is associated with the public key and/or private key; verifying the public key in the smart contract, the public key in the digital certificate, and the public key entered by entity are all identical.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present disclosure relates generally to the field of smart contracts on a blockchain. More particularly, the present disclosure relates to verifying and validating the ownership of smart contracts on a blockchain.

### DESCRIPTION OF RELATED TECHNOLOGY

The various aspects and embodiments discussed herein relate to smart contracts for a distributed ledger system, such as, but not limited to blockchain.

A smart contract is a computer program that facilitates, verifies, and enforces the negotiation or performance of a contract. It is designed to automatically execute and enforce the terms of an agreement between parties, without the need for intermediaries or centralized authorities.

Smart contracts are built on blockchain technology, most commonly associated with platforms such as Ethereum. Once deployed on the blockchain, a smart contract becomes a self-executing program that runs exactly as programmed.

In the world of blockchain, there are generally two types of systems-public blockchain (also known as permissionless blockchain) which is a decentralized, centralized or partially decentralized computer network where anyone could access and anyone could upload, install and operate software known as smart contracts on the network. The other type is private blockchain (also known as permissioned blockchain) where only selected people can access as well as upload, install and run smart contracts. Due to blockchain's often decentralized and open-source nature, it is almost impossible to determine the origin and ownership of smart contracts deployed on any blockchain networks, particularly public blockchains, such as Ethereum, because of the lack of ability to authenticate and verify the ownership of smart contracts and trace them back to their original creators.

At present, many have tried to find compelling use cases for blockchain. Some of the common blockchain applications attempt to prevent fraud and forgeries such as for digital and non-digital documents and merchandise. These applications utilize blockchain technology to store digital versions of the assets inside digital tokens such as non-fungible tokens NFTs or soulbound tokens (SBTs). Since tokens on the blockchain are created by smart contracts and these software contracts are publicly accessible and can therefore be viewed/copied by others, any individual or entity could create and deploy smart contracts on the blockchain that create NFTs or SBTs that contain forged digital copies of the actual items. Thus, this renders blockchain technology incapable of effectively solving the problem of fraud.

For instance, in 2022, Sungkyunkwan University in Seoul, South Korea, issued NFT-based certificates to their students who won their Graduation Celebration Video contest. In India during the same year, Maharashtra State Board of Skill Development (MSBSD) issued nearly 100,000 verifiable digital diplomas anchored on the Polygon public blockchain. One of the reasons why these organizations created the certificates on the blockchain is to provide a method to authenticate the documents they issued. This is achieved by the ability to trace the origin of these certificates from the smart contracts owned by the organizations. All of these cases utilized smart contracts that minted tokens containing identifiable data of each certificate. Since the organizations used public blockchains and open-source smart contracts, anyone could access and copy the actual certificate data stored in the original tokens and recreate a different, but similar smart contract program that issues forged tokens with the identical data contained inside. In short, a motivated forger could counterfeit the verification method used to prevent fraud in the first place. It would be extremely difficult for an average person to tell the difference between the genuine and fake certificates since both certificates offer a way to verify their authenticity. Moreover, each certificate is issued by two identical smart contracts which can only be differentiated by their contract address (e.g., 0xA45381a9c368d3D5Ccec160bBe50eifeAc09fD71) and the time the contract was created. To prove authenticity based on time of creation, a person needs to know all the contracts available. This is obviously a hassle. This problem is compounded by the use of third party blockchain explorer software such as Etherscan which also faces the same dilemma in distinguishing which contract is real and which is fake. At present, these online tools do not provide any visual cue on which contract is genuine such as the blue checkmark implemented by Twitter.

For permissioned blockchain, forging the verification method is also possible because there is no foolproof way to identify the ownership of a specific blockchain network even though it is private. This means a fraudster could deploy their own private blockchain to imitate another private network. The only difference is possibly their chain IDs or IP addresses which are hard for a lay person to tell apart. Although an enterprise could provide a distinctive way to authenticate their digital tokens, such as by referring back to their original website or mobile app, it would defeat the purpose of using a blockchain to solve this counterfeit issue when it involves higher capital expenditure and operation costs to operate a permissioned blockchain network compared to just running a centralized website or application that uses their existing IT infrastructure.

Virtually every document faces the same conundrum with fraud. Anyone could easily copy and/or modify a document and claim it is authentic. A user could employ an authentication system for digital or physical documents but this system can similarly be forged. Some non-exhaustive examples of common fake documents are invoices, checks, financial statements, business filings, tax returns, contracts, agreements, bank statements, personal identification documents like passports, birth certificates, social security cards, national IDs, driver's licenses, biometric residence permit (BRP) and more. So far, blockchain technology does not offer a compelling solution to solve this pressing problem although many have tried.

A company called Wraptag is using NFT to solve the counterfeit problem with physical merchandise. They have created a blockchain system that issues NFT certificates that could attest to the authentication of products. Merchandise that implements this solution would have an NFC (near field communication) tag embedded with an NFT. Consumers could use their decentralized web-based application to scan the tag to verify if a product is authentic. However, Wraptag's system uses a subnet blockchain from Avalanche. Although a subnet is a private blockchain, Avalanche is unable to prevent fraudsters from replicating a similar subnet and identical NFC tags and NFT certificates. Do note that the data for NFC tags and certificates are available publicly even on a subnet blockchain.

In the trading business of digital art on the blockchain, artists are having their digital artwork counterfeited even though the artist uploaded their art on a blockchain. Meantime, buyers have no way to verify if the digital art, such as an NFT (non-fungible token) art, they purchased is authentic. These issues are caused by the inability to verify the ownership of digital assets on the blockchain. Because digital art is stored in a form of a digital file, anyone could easily forge an exact copy and uploaded it on a blockchain while claiming they are the creator. Also, since digital art on the blockchain is created by a smart contract, any individual or entity could create and deploy a smart contract that creates blockchain tokens, like NFTs, which contain forged digital art.

Content creators automatically get copyright protection when they create their original creative work. However, these creators have been facing an unsurmountable hurdle of proving ownership of their intellectual property especially when it is infringed. The current best solution is to register their work with intellectual property offices in specific jurisdictions where the creators wish to protect their work. Often, the registration fee is substantial, and these costs quickly adds up when filing numerous creative works.

Identity theft cases have soared in recent years partly due to the increase in the use of personal identification documents particularly in the digital space. However, there has always been a fierce battle between privacy and convenience when it comes to verifying a person's identity. Service providers that are required to perform identification verification processes, such as KYC (know your customer), often resort to using and storing a copy of their users' identification documents, such as passports or driver's licenses, either digitally or physically on paper. But this method proves to be privacy intrusive and faces the risk of data leaks. There are existing solutions to mitigate this problem such as utilizing zero-knowledge proof (ZKP) technology in an identity management system. But this system requires a trusted relationship between the issuer of identification details and the verifier that wishes to verify an individual's personal data. For instance, in an identity management system such as Polygon ID, if YouTube needs to verify that a particular California resident is 18 years old or above, YouTube needs to establish a trusted connection with an identification issuer that could attest to that data, such as the California Department of Motor Vehicle. There is also identity-based encryption (IBE) where an example of a method and device employing smart contract to realize identity-based key management can be seen in U.S. patent application Ser. No. 17/440,294 filed on Jun. 18, 2019 by Dongwei Yang et. al. which describes that a smart contract executes a key management process and identity information of the target user is acquired from a blockchain. This IBE method uses user identity information, such as email addresses, phone numbers or public key, instead of digital certificates, for encryption and signature verification. Since the registered identity information is stored in the blockchain, fraudster can retrieve this data and could easily copy the user identity information of the individual or entity they intent to mimic without requiring any third-party verification.

Therefore, this system suffers from network effect phenomenon where its value and effectiveness highly depends on the number of identification data issuers and the types of data they issue.

Therefore, there is a need to authenticate and verify the ownership of each smart contract deployed on a public or private blockchain so that this system can be used effectively and efficiently to implement various use cases such as, but not limited to, prevent digital and non-digital document fraud, fight copyright infringement, provide a less privacy-intrusive method to identify a person's identity, etc.

### SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present disclosure in a simplified form as a prelude to the more detailed description that is presented later.

Various embodiments of the specification include, but are not limited to, systems and methods for authenticating and verifying smart contracts.

According to one aspect, a computer-implemented method for authenticating smart contracts includes: using existing key pair that was used to create an existing website digital certificate such as one currently used on a website; signing a message using the private key which produces a signature; entering and storing the signature, the message, the public key and the website address into a smart contract; and verifying that the signature was signed with the same public key used in the existing website digital certificate; deploying the smart contract on a blockchain.

According to one aspect, a computer-implemented method for authenticating smart contracts includes: using existing key pair that was used to create an existing website digital certificate such as one currently used on a website; entering the private key into a smart contract without storing; extracting public key from the private key; storing the extracted public key and the website digital certificate into the smart contract; verifying that the extracted public key is the same as the public key used in the website digital certificate; and deploying the smart contract on a blockchain.

According to one aspect, a computer-implemented method for authenticating smart contracts includes: generating a new key pair; obtaining a website digital certificate from a certificate authority (CA) to be used on a website; signing a message using the private key which produces a signature; entering and storing the signature, the message, the public key and the website address that will be using the website digital certificate into a smart contract; verifying that the signature was signed with the same public key used in the website digital certificate; and deploying the smart contract on a blockchain.

According to one aspect, a computer-implemented method for authenticating smart contracts includes: generating a new key pair; obtaining a digital certificate from a certificate authority (CA); signing a message using the private key which produces a signature; entering and storing the signature, the message, the public key, and the digital certificate into a smart contract; verifying that the signature was signed with the same public key used in the digital certificate; deploying the smart contract on a blockchain;

According to one aspect, a computer-implemented method for authenticating smart contracts includes: generating new key pair; obtaining a digital certificate from a certificate authority (CA); entering the private key into a smart contract without storing; extracting public key from the private key; storing the extracted public key and the digital certificate into the smart contract; verifying that the extracted public key is the same as the public key used in the digital certificate; deploying the smart contract on a blockchain.

According to one aspect, a computer-implemented method for authenticating existing smart contracts already deployed on a blockchain includes: generating a new key pair or reusing existing key pair; obtaining a new digital certificate from a certificate authority (CA); signing a message using the private key which produces a signature; verifying that the signature was signed with the public key; updating the smart contract by replacing the existing signature, the existing message, the existing public key and the existing digital certificate with the signature, the message, the public key and the new digital certificate;

According to one aspect, a computer-implemented method for authenticating existing smart contracts already deployed on a blockchain comprises: generating a new key pair or reusing existing key pair; obtaining a new digital certificate from a certificate authority (CA); entering the private key into an existing smart contract without storing; extracting the public key from the private key; storing the extracted public key and the website digital certificate into the smart contract; verifying that the extracted public key is the same as the public key used in the digital certificate; updating the smart contract by replacing the existing public key and the existing digital certificate with the extracted public key and the new digital certificate.

In some embodiments, when authenticating a smart contract, the smart contract has not been compiled and not yet been deployed on a blockchain.

In some embodiments, when authenticating a smart contract, the smart contract has been compiled and not yet been deployed on a blockchain.

In some embodiments, when authenticating a smart contract, the smart contract has been deployed on a blockchain.

In some embodiments, when authenticating a smart contract, obtaining a digital certificate comprises: (i) generating a request, such as certificate signature request (CSR), containing contents such as public key for which the certificate should be issued and identifying information (such as website address, personal ID, name, organization name, country) of an entity; (ii) verifying the contents in the request by a certificate authority (CA); and (iii) receiving the digital certificate signed by a certificate authority (CA). In some embodiments, when authenticating a smart contract, the message may be kept secret before it is signed because knowing this information, together with other information such as public key, a forger could forge the smart contract.

In some embodiments, when authenticating a smart contract, verification of the signature can happen inside or outside the smart contract, such as in the blockchain system itself.

According to one aspect, a computer-implemented method for verifying smart contracts comprises: entering and reading a smart contract address, a website address, an encryption algorithm and a private key; obtaining a website digital certificate from the website address; extracting a public key from the website digital certificate; extracting a public key from the private key; verifying that the public keys from the website digital certificate and from the private key are identical; displaying the verified status of the smart contract.

According to one aspect, a computer-implemented method for verifying smart contracts that are associated with particular websites comprises: entering a smart contract address, a website address, an encryption algorithm, and a private or public key into a user graphical interface and reading the information entered; obtaining a website digital certificate from the website address; extracting a public key from the website digital certificate; extracting a public key from the private key (if private key was entered earlier), or signing a message using the private key to obtain a signature and verifying the signature with the public key (if public key was entered earlier); and verifying that the public keys from the website digital certificate and from the private key are identical (if private key was entered earlier), or verifying that the public keys from the website digital certificate and the entered public key are identical (if public key was entered earlier).

According to one aspect, a computer-implemented method for verifying smart contracts comprises: entering a smart contract address, a digital certificate, an encryption algorithm, and a private or public key into a user graphical interface and reading the information entered; obtaining the digital certificate from the smart contract address; extracting a public key from the digital certificate; extracting a public key from the private key (if private key was entered earlier), or signing a message using the private key to obtain a signature and verifying the signature with the public key (if public key was entered earlier); and verifying that the public keys from the digital certificate and from the private key are identical (if private key was entered earlier), or verifying that the public keys from the digital certificate and the entered public key are identical (if public key was entered earlier).

In some embodiments, when verifying smart contract, access to the computer programming source code of the smart contract is required to ensure that the method of authentication of the smart contract was performed in accordance to the authentication method mentioned herein.

In some embodiments, when verifying a smart contract, once the smart contract is verified, a verified status visual cue of the smart contract is displayed on an information and content display system such as, but not limited to, Web browser or mobile application.

In some embodiments, when verifying a smart contract, once the smart contract is verified, a verified status visual cue of the smart contract together with the digital certificate and/or website address is displayed on an information and content display system such as, but not limited to, Web browser or mobile application.

### BRIEF DESCRIPTION OF THE DRAWINGS

Some embodiments of the present disclosure are illustrated as an example and are not limited by the figures of the accompanying drawings, in which like references may indicate similar elements and in which:

FIG. 1 illustrates a diagram of one example of a smart contract authentication and verification system and its devices, in accordance with various embodiments.

FIG. 2 illustrates a block diagram of one example of a computing device, in accordance with various embodiments.

FIG. 3 illustrates a block diagram of one example of a smart contract authentication system 100 and its modules, in accordance with various embodiments.

FIG. 4 illustrates a block diagram of one example of a smart contract verification system 200 and its modules, in accordance with various embodiments.

FIG. 5 illustrates a flow diagram of a method for authenticating a smart contract, according to some embodiments.

FIG. 6 illustrates a flow diagram of a method for authenticating a smart contract, according to some embodiments.

FIG. 7 illustrates a flow diagram of a method for authenticating a smart contract, according to some embodiments.

FIG. 8 illustrates a flow diagram of a method for authenticating a smart contract, according to some embodiments.

FIG. 9 illustrates a flow diagram of a method for verifying a smart contract, according to some embodiments.

FIG. 10 illustrates a flow diagram of a method for verifying a smart contract, according to some embodiments.

FIG. 11 illustrates a flowchart of a method for authenticating a smart contract, according to some embodiments.

FIG. 12 illustrates a flowchart of a method for verifying a smart contract, according to some embodiments.

FIG. 13 illustrates a flow diagram of a method for updating an authenticated smart contract, according to some embodiments.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. As used herein, the term “optional” or “optionally” means that the subsequently described event or circumstance may or may not occur, and that the description includes instances where the event occurs and instances where it does not. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the disclosure and the claims.

Prior to discussing various embodiments of the disclosure, an explanation of various terms are provided below.

A “blockchain” may refer to a distributed ledger or distributed database. That is, in the present disclosure, the phrases “distributed ledger” and “blockchain” are used. In conventional practice literature, these two concepts are often considered to be synonymous. A blockchain may be used to maintain a continuously growing list of records called blocks. A blockchain may be used to maintain a record of transaction or data that is difficult to falsify. Each block in a blockchain may include several records as well as a hash of previous blocks in the blockchain. If a record in a previous block is changed, the hash may be disrupted in any following blocks. Additionally, a blockchain may be distributed among a large number of entities. Any changes to the blockchain may be verified by comparing it to the numerous individual records. A blockchain may be comprising a decentralized, centralized, or partially centralized network of nodes. Nodes may refer to computing devices or large computer systems that support the blockchain network and keep it operating smoothly. Each node may provide a part or all of the functions of the blockchain. A blockchain may be connected to one or more subnets. A subnet, also known as parachain in other blockchain contexts, refers to a subset of nodes within a blockchain network that are responsible for processing and validating transactions specific to a particular portion or partition of the network. Each subnet may operate as an independent blockchain with its own set of rules and consensus mechanisms, allowing the subnet to process transactions and execute smart contracts autonomously within its designated portion of the network. A blockchain may be connected to one or more sidechains. A sidechain may be a separate and independent blockchain that runs in parallel to a main or parent blockchain. Sidechain may be designed to be interoperable with the main blockchain, allowing assets and data to be transferred between the two blockchains in a secure and trustless manner. The main purpose of sidechains may be to address scalability and performance limitations of the main blockchain. By moving some transactions off the main blockchain and onto a sidechain, the overall throughput and efficiency of the entire blockchain ecosystem may be improved. Blockchain networks may either be public, private, or partially public. Public blockchain networks may be open to all and any user can utilize the benefits the network offers such as deploying and operating smart contracts and view all the transactions on the network. Private blockchain networks may be controlled and operated by a single organization or group of organizations and may be used by selected users, such as to deploy and operate smart contracts. Public blockchain networks may generally be permissionless, meaning any node can participate. However, some public blockchain networks may adopt a permissioned model where the blockchain is controlled by a pre-selected set of nodes. Private blockchain networks may generally adopt the permissioned model. A blockchain network may interoperate with other blockchain networks. This interoperability may be performed via a bridge. A blockchain bridge may act as connector that facilitate the transfer of assets and data between different blockchains, allowing them to communicate and interact with each other. A blockchain bridge may play a vital role in enabling cross-chain functionality, which is essential for various use cases and improving overall scalability and efficiency of blockchain networks. A blockchain may be divided into Layer 1 (L1) blockchain and Layer 2 (L2) blockchain. Layer 1 blockchain may refer to primary or parent blockchain network while Layer 2 blockchain may be built on top of the primary blockchain (Layer 1) to address the scalability limitations of the primary blockchain (Layer 1). Layer 2 blockchain may aim to improve transaction throughput and reduce fees without compromising on the security and decentralization properties of the underlying Layer 1 blockchain.

The primary motivation for implementing Layer 2 solutions is to overcome the inherent scalability challenges faced by many blockchain networks, such as Bitcoin and Ethereum. These networks typically have limited transaction processing capacity and can handle only a certain number of transactions per second. As the demand for blockchain-based applications and services increases, congestion on Layer 1 can lead to slower transaction times and higher transaction fees.

A “key pair” may include a pair of linked encryption keys which is part of public-key cryptography. For instance, a key pair may include a public key and a corresponding private key. In a key pair, a first key (e.g., a public key) may be used to encrypt a message, while a second key (e.g., a private key) may be used to decrypt the encrypted message. Additionally, a public key may be able to verify a digital signature created with the corresponding private key. The public key may be distributed throughout a network in order to allow for verification of messages signed using the corresponding private key. Public and private keys may be in any suitable format, including those based on RSA or elliptic curve cryptography (ECC). In some embodiments, a key pair may be generated using an asymmetric key pair algorithm.

A “website address,” may also be known as a URL (Uniform Resource Locator), may refer to a unique string of characters that identifies the location of a specific webpage or resource on the Internet. A typical website address may comprise of several components: (a) a protocol that may indicate the method used to access the resource. The most common protocol may be “http://” (hypertext transfer protocol) or its secure version “https://”, which encrypts data transmission between the website and Web browser; (b) a domain name that may identify the specific website. The domain name may correspond to the entity or individual owning the website; (c) a subdomain that may be an optional part of the address and appears before the main domain name. The subdomain may provide additional context or indicate a specific section of the website; (d) a top-level domain (TLD) that may refer to the last part of the domain name and indicates the website's category or geographic location; (e) a path that may come after the domain name and specifies the specific webpage or resource within the website.

A “digital certificate” may refer to an electronic document utilized to prove ownership. It may contain a public key or information about a public key, as well as the owner's identity associated with that public key. Additionally, a digital certificate may include a digital signature, which is information indicating the entity that verified the ownership of the public key. The digital signature may be a message encrypted with the verifying entity's private key. By decrypting the message with the verifying entity's public key, one may identify the verifying entity. The format for a digital signature may be X.509 that may be widely used in public key infrastructure (PKI) systems. X.509 may define the structure and content of certificates, which are used for authentication, encryption, and digital signatures in various applications. X.509 certificates may typically be issued by trusted certificate authorities (CAs) who digitally sign the certificates using their private key. The CA's digital signature may serve as a trust anchor, allowing relying parties to verify the authenticity and integrity of the certificate using the CA's public key.

A “certificate authority” may refer to a reliable entity responsible for issuing certificates to verify the identities of other entities. For instance, a certificate authority may issue a digital certificate that contains details about a cryptographic key and the owner's identity associated with that key. The certificate authority may digitally sign the certificate to verify the digital certificate's authenticity. Various examples of certificate authorities can include governmental departments, corporations, banks, associations, clubs, DAOs (distributed autonomous associations), notaries, notary signing agents or even individuals, among others.

A “public key infrastructure” (PKI) may refer to a set of policies, procedures, and technologies used to manage the creation, distribution, use, storage, and revocation of digital certificates. PKI may provide a framework for secure communication and enables the implementation of various security services such as encryption, authentication, and digital signatures. PKI may operate based on asymmetric cryptography, which may involve the use of a key pair consisting of a public key and a private key. The public key may be included in the digital certificate and can be freely shared, while the private key may be kept secret by the certificate holder. The private key may be used for decrypting encrypted messages, signing digital content, or proving one's identity during authentication.

A “message” may refer to a message containing characters that only is known by the entity or the individual that owns the smart contract. The message may contain alphanumeric or non-alphanumeric characters.

A “message digest”, may also be known as a hash value, is a fixed-size, unique digital fingerprint or checksum generated from input data of any arbitrary size. The purpose of a message digest is to provide a compact representation of the input data while ensuring data integrity and authenticity. The process of generating a message digest involves applying a cryptographic hash function to the input data. A cryptographic hash function is a mathematical algorithm that takes an input (or “message”) and produces a fixed-size output, which is the message digest. The resulting digest is typically represented as a sequence of hexadecimal digits.

A “signature,” may also be known as a digital signature, represent an electronic endorsement used for messages or data. A signature may take various forms, such as numeric or alphanumeric values, or even graphical representations. A signature may be a unique data value generated from a message and a private key using an encryption algorithm. In some embodiments, a validation algorithm using a public key may be used to verify the signature. In some embodiments, we can recover the public key from the signature, such as in Elliptic Curve Digital Signature Algorithm (ECDSA).

A “DAO” may refer to a Decentralized Autonomous Organization and may refer to an organization that operates based on smart contracts and blockchain technology, without the need for centralized control or intermediaries. DAOs may be designed to be transparent, democratic, and autonomous, allowing participants to make collective decisions and manage resources in a decentralized manner. In a DAO, the rules and operations may be encoded in smart contracts, which may be self-executing agreements running on a blockchain. These smart contracts may define the governance structure, decision-making processes, and distribution of resources within the organization. The participants of a DAO may hold tokens or shares that represent their ownership or voting rights. DAOs have gained attention for their potential to revolutionize traditional organizational structures and enable new forms of collaboration, crowdfunding, and decentralized governance.

A “smart contract” may refer to a computer program that runs on a blockchain and automatically executes predefined actions when certain conditions are met. A smart contract may be a self-executing contract with the terms of the agreement directly written into the computer code. When a smart contract is deployed, a decentralized application (dapp) that can interact with the blockchain may be created. Parties involved in the contract may then interact with the dapp to trigger actions or access information. One of the key features of smart contracts may be their ability to enforce the agreed-upon terms and conditions without relying on a central authority. Once the predefined conditions are met, the contract may be executed automatically and the results are recorded on the blockchain, providing transparency and trust to all parties involved.

A “block explorer” may refer to a software or website that allows users to explore and navigate through a blockchain. It may provide a graphical interface to view and analyze various data related to the blockchain, such as blocks, transactions, addresses, and other relevant information. A block explorer may enable users to track the flow of transactions, view the details of individual blocks and transactions, check wallet balances, and verify the status of a specific transaction or address. A block explorer may include: the display of information about each block, such as block height, timestamp, size, and the transactions included in the block; provide information about smart contract and wallet transactions including the sender and recipient addresses, transaction amount, transaction fee, and confirmation status; search functionality for specific wallet addresses and view the transaction history, balance, and other relevant details.

A “wallet”, may also be known as a blockchain wallet or digital wallet, may refer to a software application or a physical device that allows users to securely store, manage, and interact with their cryptocurrencies or a blockchain. A wallet may be designed to provide a user-friendly interface and facilitate the sending, receiving, and storage of digital assets on a blockchain network. A blockchain wallet may not actually store the cryptocurrencies themselves, but it stores the private keys necessary to access and control the funds associated with the wallet.

An “SSL/TLS digital certificate” may refer to a digital certificate that allows systems to verify the identity and subsequently establish an encrypted network connection to another system using the Secure Sockets Layer/Transport Layer Security (SSL/TLS) protocol. Digital certificates may be used within a cryptographic system known as a public key infrastructure (PKI). PKI may provide a way for one party to establish the identity of another party using digital certificates if they both trust a third-party, such as a certificate authority. SSL/TLS certificates may act as digital identity cards to secure network communications, establish the identity of websites over the Internet as well as resources on private networks.

A “constructor function” may refer to a special type of function in programming languages that is used to create and initialize objects. It may be called when an object is instantiated or created from a class or a blueprint. The main purpose of a constructor function may be to set up the initial state or properties of the object. The constructor function may define variables, assign values to properties, and perform any necessary setup or initialization tasks. Specific values or parameters may be defined in the constructor function that are required for the object to be created correctly.

A “function”, may also be known as “programming function,” is a named block of code that performs a specific task or set of tasks. It is a fundamental building block of modular and reusable programming code. Functions are designed to take input (arguments or parameters), process that input, and return an output. A smart contract function refers to a block of code or a set of instructions written within a smart contract, which is a self-executing contract with the terms of the agreement written directly into code. The idea behind using functions is to break down a complex problem into smaller, manageable tasks, making the code easier to read, understand, and maintain. Functions allow developers to encapsulate functionality, promote code reusability, and improve the overall organization of the codebase.

A “hash function” may refer to a mathematical function that takes an input (or message) and returns a fixed-size string of characters, which is typically called a hash, a hash value, or hash code. The purpose of a hash function may be to efficiently map data of arbitrary size to a fixed-size value. Hash functions may widely be used in computer science and cryptography for various purposes, including data storage, data retrieval, data integrity verification, and password hashing.

The “RSA algorithm” may refer to a widely used asymmetric cryptographic algorithm that is named after its inventors: Ron Rivest, Adi Shamir, and Leonard Adleman. The RSA Algorithm may be commonly used for secure communication, digital signatures, and encryption of sensitive data. The RSA algorithm may be based on the mathematical properties of large prime numbers and modular arithmetic. The RSA algorithm may use a pair of keys: a public key for encryption and a private key for decryption. The keys may be generated in such a way that the private key cannot be easily derived from the public key. The security of the RSA algorithm may be based on the difficulty of factoring large composite numbers into their prime factors. The larger the prime numbers used in the key generation process, the more secure the encryption becomes. The RSA algorithm may be widely used in various applications, including secure communication protocols like HTTPS, digital signatures, secure email, secure file transfer, and secure data storage. The RSA algorithm may provide a robust mechanism for secure data transmission and may protect sensitive information from unauthorized access.

“SHA-256” may refer to a widely used cryptographic hash function. It may be a member of the SHA-2 (Secure Hash Algorithm 2) family, which includes various hash functions with different output sizes, such as SHA-224, SHA-256, SHA-384, and SHA-512. SHA-256 may take an input message of any/an arbitrary length and produces a fixed-size hash value of 256 bits (32 bytes).

A “certificate signing request” (CSR) may refer to a file generated by an entity to request a digital certificate from a certificate authority (CA). The CSR may contain information about the entity (e.g., website address, personal ID, name, organization name, country, etc.) and the public key of the entity, which may be used by the CA to issue the requested digital certificate. By submitting a CSR to a trusted CA, an entity may obtain a digital certificate that provides authentication, encryption, and integrity for their activities. The digital certificate may serve as proof of identity and allows others to verify the authenticity and trustworthiness of the entity's communications or transactions. The process and requirements for generating a CSR may vary depending on the specific CA and the purpose of the certificate (e.g., SSL/TLS certificate, code signing certificate, etc.). The CA's documentation or website typically provides instructions and guidelines for generating and submitting a CSR.

“OpenSSL” is a widely used open-source software library that provides cryptographic functions and protocols for secure communication, encryption, and certificate management. OpenSSL is used in numerous applications and systems, including web servers (e.g., Apache, Nginx), email servers (e.g., Postfix, Sendmail), virtual private networks (VPNs), secure file transfer protocols (SFTP), and software development libraries. Developers can leverage OpenSSL's Application Programming Interfaces (APIs) and libraries to incorporate secure communication, encryption, and certificate management features into their applications. The command-line tools provided by OpenSSL may be used for performing various cryptographic operations and managing certificates from the command line.

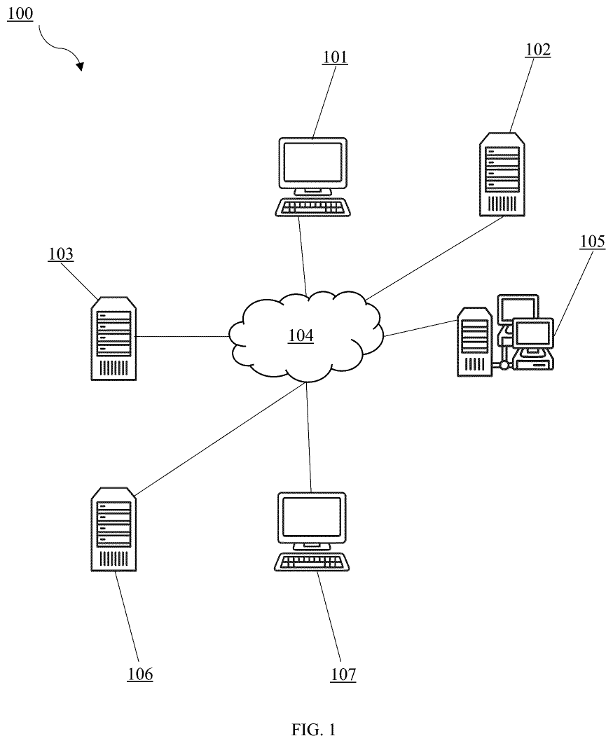

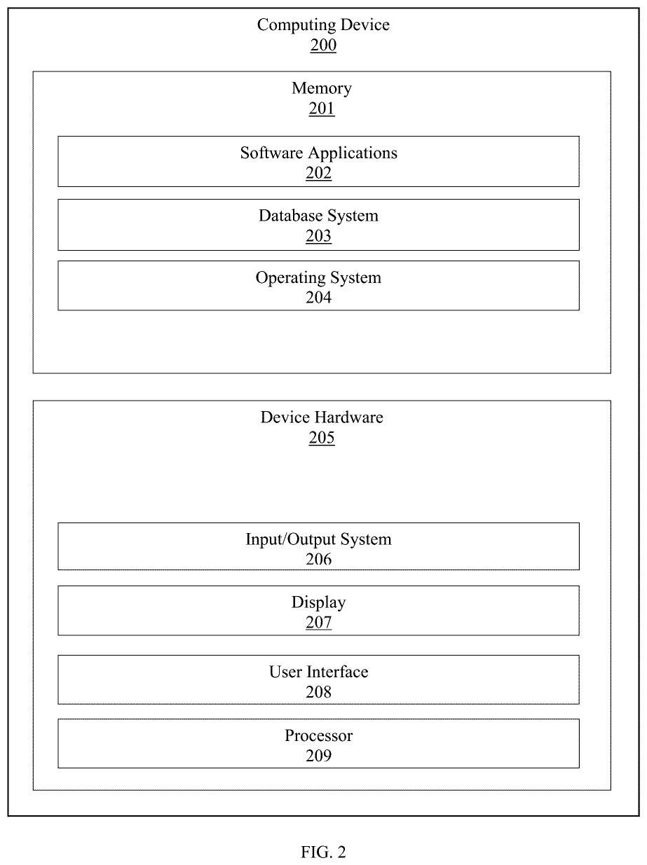

FIG. 1 shows an operating environment 100. The operating environment 100 may include client and server devices such as client device 101 and 107, a web server 102, a digital certification server 103, network 104, blockchain system 105 and a block explorer server 106. It will be appreciated that the network connections 104 shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices described with respect to FIG. 2.

Client device 101 may be used by an entity to authenticate ownership of smart contract and deploy smart contract on blockchain as described herein. Client device 101 may contain smart contract computer source code that entity wishes to authenticate and deploy on blockchain system 105. Client device 101 may communicate with web server 102 to retrieve existing digital certificate of existing website and communicate with digital certification server 103 to obtain key pair. Web server 102 may host website owned or managed by entity. Web server 102 may store the digital certificate of website it hosts and transmits the digital certificate to requesting computing devices such as client device 101 and block explorer server 106. Digital certification server 103 may issue digital certificate for entity and for website hosted by web server 102. Blockchain system 105 may be a set of connected computing devices, known as nodes, which acts as a collective blockchain system. Blockchain system 105 may consists of one or more sets of blockchain systems that are interconnected with one another via a mechanism such as a bridge. Blockchain system 105 may store and host smart contracts such as the smart contract deployed by entity via client device 101.

Block explorer server 106 may provide and store information of smart contracts particularly verification information of smart contract ownership described herein. Block explorer 106 may allow entity using client device 101 to upload data to verify that they own a smart contract deployed by entity on blockchain system 105. Block explorer 106 may obtain digital certificates of websites from web server 102. Block explorer server 106 may host a website that provide a user interface that enable users using client device 107 to access verified and non-verified information of smart contract on blockchain system 105. Client device 107 may be used by a user to verify the ownership of smart contracts deployed on blockchain. Client device 107 may request verified ownership information from block explorer server 106 about a smart contract deployed on blockchain system 105.

It should be noted that any computing device in the operating environment 100 may perform any of the processes and/or store any data as described herein. A blockchain system 105 may be publicly accessible and/or have restricted access. Access to a blockchain system 105 may be limited to particular client devices 101 and 107. Some or all of the data described herein may be stored using one or more databases. Databases may include, but are not limited to relational databases, hierarchical databases, distributed databases, in-memory databases, flat file databases, XML databases, JSON database, NoSQL databases, graph databases, object storage, and/or a combination thereof. The network 104 may include a local area network (LAN), a wide area network (WAN), a wireless telecommunications network, and/or any other communication network or combination thereof.

FIG. 2 illustrates a block diagram of a computing device 200, according to some embodiments. Computing device 200 may include device hardware 205 coupled to a memory 201. Device hardware 205 may include an input/output system 206, a display 207, a user interface 208, and a processor 209. Input/output system 206 may include internal or external computer peripherals that are connected to computing device 200. In some embodiments, display 207 may be part of user interface 208. User interface 208 may include software or hardware elements to allow a user to interact with computing device 200. Processor 209 can be implemented as one or more integrated circuits (e.g., one or more single core or multicore microprocessors and/or microcontrollers), and is used to manage and control the operation of computing device 200.

Memory 201 can be implemented using any combination of any number of non-volatile memories (e.g., flash memory, disk storage, hard disk drives, optical discs, floppy disks, and magnetic tapes) and volatile memories (e.g., DRAM, SRAM), or any other non-transitory storage medium, or a combination thereof media. Memory 201 may store software applications 202, database system 203 and operating system 204. Software applications 202 may include a provider specific application used for accessing a resource from a resource provider, general purpose application such as a web browser, or other suitable applications. Examples of software applications may include blockchain applications, smart contract applications, smart contract development applications, cryptography applications such as OpenSSL, public key infrastructure (PKI) application, web server application, database application, website application and files, block explorer application, integrated development environment (IDE), software development tools, software compiler, software libraries, etc. In some embodiments, software application functions may include generating key pair, issuing and/or reading digital signature, programming smart contract, compiling smart contract, deploying smart contract, authenticating the ownership of smart contract, verifying the ownership of smart contract and more. Examples of computing devices are servers, computers, mobile phones, Internet of Things (IoT) devices, etc.

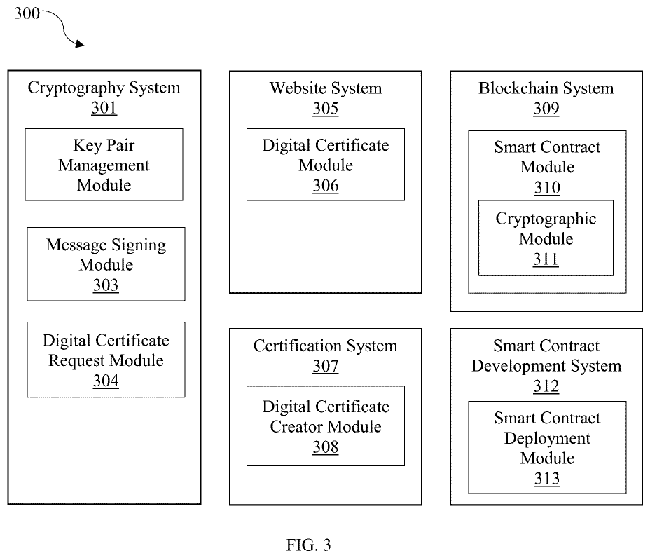

FIG. 3 shows an example of a smart contract authentication system 300 for performing various disclosed steps and methods, in accordance with various embodiments. As shown, the system 300 may comprise a cryptography system 301, website system 305, certification system 307, blockchain system 309 and smart contract development system 312, each of which may correspond to one or more physical hardware devices or virtual devices coupled together via various types of communications networks.

Each of the cryptography system 301, website system 305, certification system 307, blockchain system 309 and smart contract development system 312 may be implemented in one or more computing devices 200 shown in FIG. 2. Each of the cryptography system 301, website system 305, certification system 307, blockchain system 309 and smart contract development system 312 may work with some or all the other devices depicted in FIG. 1. In one embodiment, an entity that wishes to deploy a smart contract on a blockchain may use smart contract authentication system 300 to authenticate their ownership of their smart contract.

Although the cryptography system 301, website system 305, certification system 307, blockchain system 309 and smart contract development system 312 are shown as single components in this figure, it should be appreciated that these systems can be implemented as a single or multiple devices coupled together.

The cryptography system 301 may contain a key pair management module 302 for managing key pairs of public and private keys; a message signing module 303 for signing message using private keys; a digital certificate request module 304 for generating requests in order to obtain digital certificates from certificate authority (CA). In some embodiments, the cryptography system 301 may be an OpenSSL-based system running on a computing device 200 shown in FIG. 2 and interconnected with other devices as shown in FIG. 1.

The website system 305 may contain a digital certificate module 306 that transmits digital certificates of websites it hosts. In some embodiments, the website system 305 may be a web server like Apache running on a computing device 200 shown in FIG. 2 and interconnected with other devices as shown in FIG. 1.

The certification system 307 may contain a public key infrastructure (PKI) and may contain digital certificate creator module 308 that issues digital certificates. The certification system 307 may be managed and controlled by a certificate authority (CA). In some embodiments, the certification system 307 may refer to a system managed by corporations such as Verisign or Digicert running on a computing device 200 shown in FIG. 2 and interconnected with other devices as shown in FIG. 1.

The blockchain system 309 may contain a smart contract module 310 that may be a smart contract software application. In some embodiments, the blockchain system 309 may refer to a system implemented on a computing device 200 shown in FIG. 2 and interconnected with other devices as shown in FIG. 1. The smart contract module 310 may contain a cryptographic module 311 that may perform cryptographic functions such as (i) signing a message using private key to produce a signature; (ii) verifying if a signature was produced by a key pair; (iii) extracting public key from digital certificate or signature; and (iv) storing the message, signature, public key, digital certificate, website address, etc. The smart contract module 310 can be in a form of (i) programming source code that has yet to be compiled; (ii) bytecode or machine code that has been compiled but yet been deployed; or (iii) or an application has been deployed on a blockchain.

The smart contract development system 312 may contain a smart contract deployment module 313 that may manage the deployment aspect of smart contracts onto a blockchain such as smart contract code writing, code compiling and smart contract deployment. The smart contract development system 312 may contain software development software applications and tools. In some embodiments, the software development software applications and tools may be Remix IDE (integrated development environment), Visual Studio Code, Truffle, Hardhat, Web3.js software library, Ethers.js software library, software development compiler, software development interpreter, blockchain wallets, blockchain virtual machine, blockchain node, etc. In some embodiments, the smart contract development system 312 may refer to a system implemented on a computing device 200 shown in FIG. 2 and interconnected with other devices as shown in FIG. 1.

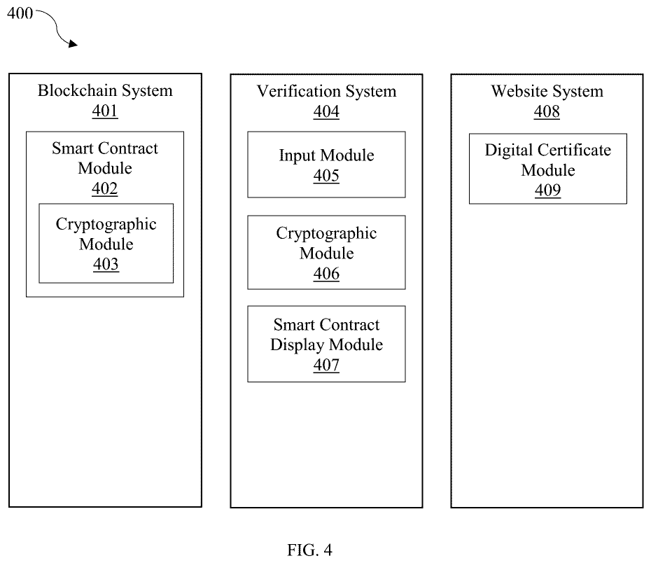

FIG. 4 shows an example of a smart contract verification system 400 for performing various disclosed steps and methods to verify the ownership of smart contracts, in accordance with various embodiments. As shown, the system 400 may comprise a blockchain system 401, a verification system 404 and website system 408, each of which may correspond to one or more physical hardware devices or virtual devices coupled together via various types of communications networks.

Each of the blockchain system 401, verification system 404 and website system 408 may be implemented in one or more computing devices such as servers, computers, mobile phones, Internet of Things (IoT) devices, etc. Each of the blockchain system 401, verification system 404 and website system 408 may work with some or all the other systems depicted in FIG. 4.

Although the blockchain system 401, verification system 404 and website system 408 are shown as single components in this figure, it should be appreciated that these systems can be implemented as single or multiple devices coupled together.

The blockchain system 401 may be similar to the blockchain system 309 depicted in FIG. 3.

The verification system 404 may contain an input module 405 that allows an entity to enter information to verify a smart contract. The information provided may be data that identifies the ownership of the smart contract such as smart contract address, wallet address, encryption algorithm, key pair, message, signature, etc. In some embodiments, the encryption algorithm may be the RSA algorithm and the key pair may be generated using the RSA algorithm.

The verification system 404 may contain a cryptographic module 406. In some embodiments, the verification system 404 may be a block explorer.

The verification system 404 may contain a smart contract display module 407 that displays the transactions history, input and output data and all other activities performed by a smart contract in a blockchain. In some embodiments, the smart contract display module 407 may be a graphical user interface such as a webpage. The smart contract display module 407 may display a visual cue to indicate if a smart contract has been verified. In some embodiments, the visual cue may be a checkmark. For example, if may be a blue checkmark that looks similar to the one used on a Twitter account. The smart contract display module 407 may display information about a digital certificate and website address stored in a smart contract. For example, the smart contract display module 407 may display an individual or organization name that owns the digital certificate, the public key of the digital certificate, the date the digital certificate was issued and the expiry date, the entity that issued the digital certificate, etc. The website system 408 may be similar to the website system 305 depicted in FIG. 3.

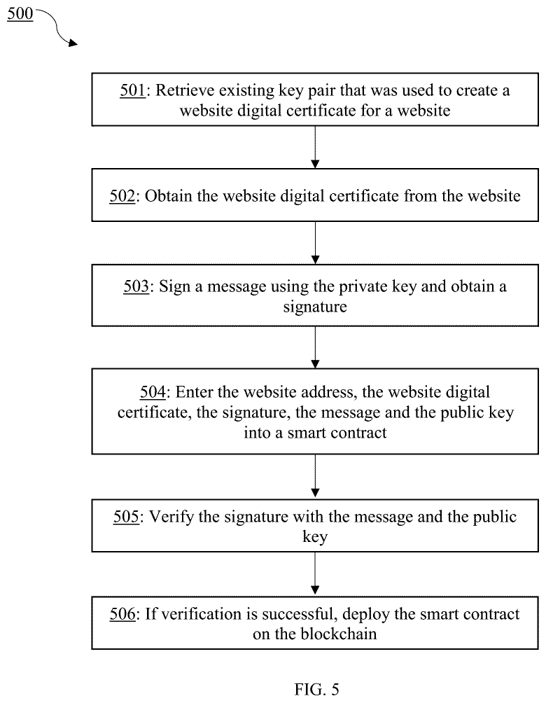

FIG. 5 illustrates a flow diagram of an example of a method 500 for authenticating a smart contract, according to some embodiments. In some embodiments, method 500 may be performed by an entity that owns a website and wishes to deploy a smart contract on a blockchain. For example, an entity may be an enterprise that owns an existing website that wishes to deploy their own smart contract where their ownership of their smart contract can be authenticated by reusing their existing digital certificate used in their website. In some embodiments, an entity deploying a smart contract may prefer to safeguard their private key, thus reluctant to enter the private key into a smart contract. Thus, they may use the option of signing a message as illustrated in this method 500. The method 500 may be implemented by one or more components of the system 300 of FIG. 3. The method 500 may be implemented by a system running on a computing device 200 shown in FIG. 2 and interconnected with other devices as shown in FIG. 1. The operations presented below are intended to be illustrative. Depending on the implementation, the method 500 may include additional, fewer, or alternative steps performed in various orders or in parallel.

At step 501, an entity using a client device 101 in FIG. 1 retrieves an existing key pair comprising of a public and a private key. In some embodiments, the existing key pair was used to create a digital certificate for an existing website. In one embodiment, to authenticate a smart contract, an entity may reuse its own existing key pair that was used to create a digital certificate of its website to indicate that they own both the website and the smart contract. This embodiment may enable the identification of ownership of a smart contract by referring back to the website that shares the same digital certificate with the smart contract. In some embodiments, the website digital certificate may be an SSL/TLS digital certificate. The cryptography system 301 in FIG. 3 may retrieve the existing key pair. In some embodiments, the existing key pair was generated using a key pair generating algorithm to generate the public-private key pair, e.g., the RSA algorithm.

At step 502, the client device 101 obtains the website digital certificate from the website. The client device 101 may request for the website digital certificate from web server 102 shown in FIG. 1 and the web server 102 transmits the website digital certificate back to client device 101. The digital certificate can be transmitted by the digital certificate module 306 in the website system 305 depicted in FIG. 3. This digital certificate may be used to identity the ownership of the smart contract that will be deployed in subsequent steps.

At step 503, client device 101 shown in FIG. 1 signs a message using the private key in the key pair in step 501 to obtain a signature. The message and signature may be used to verify the ownership of the key pair and the ownership of the website digital certificate, and in turn verifies the ownership of a smart contract in subsequent steps. For example, an entity that wishes to deploy an authenticated smart contract may use client device 101 to sign a message using its private key and obtain a signature. Step 503 can be performed by key pair management module 302 in system 300 in FIG. 3. In some embodiments, the message may contain alphanumeric or non-alphanumeric characters. In some embodiments, signing the message may include (i) creating a message digest from the message using a hash function, for example, the hash function SHA-256; and (ii) creating a signature by encrypting the message digest using the private key.

At step 504, an entity using client device 101 enters data to be included in the smart contract. This step may be implemented by the smart contract deployment module 313 depicted in FIG. 3. The data may include the website address, the website digital certificate, the signature, the message and the public key of the user. In some embodiments, the smart contract may be programming source code that has yet to be compiled and the website address, the website digital certificate, the signature, the message and the public key can be entered inside the constructor function in the source code. In some embodiments, the smart contract may already be compiled but yet to be deployed on a blockchain.

At step 505, the client device 101 verifies the signature with the message and the public key where the signature, the message and the public key were all entered into a smart contract in step 504. This step may be performed by smart contract deployment module 313 shown in FIG. 3. The purpose of this step may be to verify that the signature, the message and the public key are a match and the signature, the message and the public key are owned by the entity that is deploying the smart contract. For example, it may prove that the key pair owned by the entity and the message written by the entity were used to generate the signature. In some embodiments, the verification process may be comprising: (i) obtaining the message digest by decrypting the signature using the public key; (ii) creating another message digest from the message from step 503 using a hash function where the hash function can be using SHA-256; and (iii) comparing the message digest obtained from (i) with the message digest from (ii) and if the two digests match, it may indicate that the signature is verified. In some embodiments, step 505 may be performed by the entity using client device 101 shown in FIG. 1. In some embodiments, step 505 may be performed using OpenSSL. In some embodiments, step 505 may be performed using smart contract function.

At step 506, the client device 101 deploys the smart contract on the blockchain system 105 in FIG. 1, if the verification process in step 505 is successful. This step may be performed by smart contract deployment module 313 in the smart contract development system 312 shown in FIG. 3. In some embodiments, the client device 101 may send the smart contract data to the blockchain system 105, and blockchain system 105 may receive the smart contract data, store and operate the smart contract. In some embodiments, the smart contract may contain the website address, the website digital certificate, the signature, the message and the public key which may be accessed by users who are using the blockchain by calling certain smart contract function or variable that transmits the website address, the website digital certificate, the signature, the message or the public key.

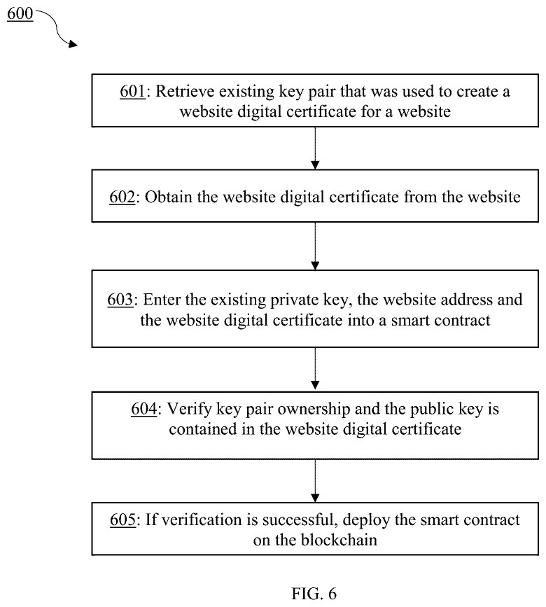

FIG. 6 illustrates a flow diagram of an example of a method 600 for authenticating a smart contract, according to some embodiments. The method 600 may be similar to method 600 except that the entity performing method 600 may be willing to enter the entity's private key into a smart contract that the entity wishes to deploy. In some embodiments, method 600 may be performed by an entity that wishes to deploy a smart contract on a blockchain and already owns a website. For example, an entity may be an enterprise that owns an existing website that wishes to deploy their own smart contract where their ownership of their smart contract can be authenticated. The method 600 may be implemented by one or more components of the system 300 of FIG. 3. The method 600 may be implemented by a system running on a computing device 200 shown in FIG. 2 and interconnected with other devices as shown in FIG. 1. The operations presented below are intended to be illustrative. Depending on the implementation, the method 600 may include additional, fewer, or alternative steps performed in various orders or in parallel. In some embodiments, method 600 may be carried out by an entity that wishes to deploy an authenticated smart contract on a blockchain.

At step 601, a client device 101 in FIG. 1 retrieves an existing key pair comprising of a public and a private key. In some embodiments, the existing key pair was used to create a website digital certificate for a website. In some embodiments, the website digital certificate may be an SSL/TLS digital certificate. In some embodiments, the existing key pair may be generated using the RSA algorithm.

At step 602, client device 101 obtains the website digital certificate from the website. This digital certificate may be used to identity the ownership of the smart contract that will be deployed in subsequent steps. This website digital certificate may be used verify the ownership of a smart contract to other users. The client device 101 may request for the website digital certificate from web server 102 shown in FIG. 1 and the web server 102 may respond with the website digital certificate. The digital certificate can be transmitted by the digital certificate module 306 in depicted in FIG. 3.

At step 603, an entity using client device 101 enters the private key from the existing key pair, the website address and the website digital certificate into a smart contract. This step may be implemented by the smart contract deployment module 313 depicted in FIG. 3. In some embodiments, the smart contract may be programming source code that has yet to be compiled and the website address, the website digital certificate, and the private key can be entered inside the constructor function in the source code. In some embodiments, the smart contract may already be compiled but yet to be deployed on a blockchain. The private key may be entered in the smart contract but not permanently stored in the smart contract which renders the private key inaccessible from the smart contract once it is deployed on a blockchain.

At step 604, the smart contract deployment module 313 in the smart contract development system 312 shown in FIG. 3 verifies that the entity is the owner of the existing key pair in step 601 and verifies that the public key of the existing key pair is contained in the website digital certificate. In some embodiments, this step may be performed by the entity using client device 101 shown in FIG. 1. In some embodiments, this step may be performed using smart contract function. In some embodiments, this step may be performed using OpenSSL. In some embodiments, step 604 may include: (i) extracting the public key from the private key by running a command on OpenSSL (for example, the “openssl rsa” command with the “-pubout” flag may extract a public key from a private key); (ii) extracting public key from the website digital certificate by running a command on OpenSSL (for example, the “openssl x509” command with the “-pubkey” flag may extract a public key from a digital certificate); and (iii) determining if the public key in (i) matches the public key in (ii). If it is a match, this may verify that the entity owns the existing key pair and the website digital certificate.

At step 605, the client device 101 deploys the smart contract on the blockchain system 105 in FIG. 1, if the verification process in step 604 is successful. This step may be performed by smart contract deployment module 313 shown in FIG. 3. In some embodiments, the client device 101 may send the smart contract data to the blockchain system 105, and blockchain system 105 may receive the smart contract data, store and operate the smart contract. In some embodiments, the smart contract may contain the website address and the website digital certificate entered in step 603 which may be accessed by users who are using the blockchain by calling certain smart contract function or variable that transmits the website address or the website digital certificate.

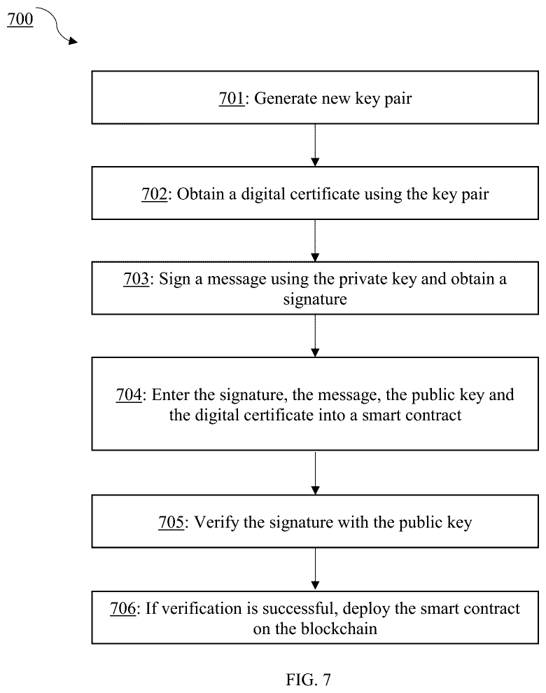

FIG. 7 illustrates a flow diagram of an example of a method 700 for authenticating a smart contract, according to some embodiments. In some embodiments, method 700 may be performed by an entity that wishes to deploy a smart contract on a blockchain who may not already own a website. For example, an entity may be an individual who wishes to deploy a smart contract where their ownership of their smart contract can be authenticated. In some embodiments, an entity deploying a smart contract may prefer to safeguard their private key, thus reluctant to enter the private key into a smart contract. Thus, they may use the option of signing a message as illustrated in this method 700. The method 700 may be implemented by one or more components of the system 300 of FIG. 3. The method 700 may be implemented by a system running on a computing device 200 shown in FIG. 2 and interconnected with other devices as shown in FIG. 1. The operations presented below are intended to be illustrative. Depending on the implementation, the method 700 may include additional, fewer, or alternative steps performed in various orders or in parallel.

At step 701, a client device 101 in FIG. 1 generates a new key pair consisting of a private key and a public key. Step 701 may be performed by an entity using OpenSSL installed in a client device 101 by executing OpenSSL available commands.

At step 702, the entity obtains a new digital certificate using the key pair in step 701 from a certificate authority (CA). In some embodiments, obtaining a digital certificate includes: (i) the entity using client device 101 with OpenSSL generating a request, such as certificate signature request (CSR), containing contents such as public key for which the certificate should be issued and identifying information (such as website address, personal ID, name, organization name, country) of the entity; (ii) client device 101 sending the request to a certificate authority (CA) and the certificate authority (CA) receiving the request via digital certification server 103 depicted in FIG. 1 and verifying the contents in the request; and (iii) certificate authority (CA) issuing a new digital certificate signed by the certificate authority (CA) and sending the digital certificate back to the client device 101. The digital certificate may be transmitted by the digital certificate creator module 308 in system 300 depicted in FIG. 3.

At step 703, client device 101 signs a message using the private key in the key pair in step 701 to obtain a signature. The message and signature may be used to verify the ownership of the key pair and the ownership of the website digital certificate, and in turn verify the ownership of a smart contract in subsequent steps. For example, an entity that wishes to deploy a smart contract may use client device 101 with OpenSSL to sign a message using its private key and obtain a signature. Step 703 can be performed by key pair management module 302 in cryptography system 301 in FIG. 3. In some embodiments, the message to be signed may contain alphanumeric or non-alphanumeric characters. In some embodiments, signing the message may include (i) creating a message digest from the message using a hash function, for example, the hash function SHA-256; and (ii) creating a signature by encrypting the message digest using the private key.

At step 704, an entity using client device 101 enters data to be included in the smart contract. This step may be implemented by the smart contract deployment module 313 depicted in FIG. 3. The data may include the digital certificate, the signature, the message and the public key of the user. In some embodiments, the smart contract may be programming source code that has yet to be compiled and the digital certificate, the signature, the message and the public key can be entered inside the constructor function in the source code. In some embodiments, the smart contract may already be compiled but yet to be deployed on a blockchain.

At step 705, the smart contract deployment module 313 shown in FIG. 3 verifies the signature with the message and the public key where the signature, the message and the public key were all entered into a smart contract in step 704. For example, this step may be performed by an entity using client device 101. In some embodiments, this step may be performed using OpenSSL. In some embodiments, this step may be performed using smart contract function. The purpose of this step may be to verify that the signature, the message and the public key are a match and the signature, the message and the public key are owned by the entity that is deploying the smart contract. For example, it may prove that the key pair owned by the entity and the message written by the entity were used to generate the signature. In some embodiments, the verification process may be comprising: (i) obtaining the message digest by decrypting the signature using the public key; (ii) creating another message digest from the message from step 703 using a hash function where the hash function can be using SHA-256; and (iii) comparing the message digest obtained from (i) with the message digest from (ii) and if the two digests match, it may indicate that the signature is verified.

At step 706, the client device 101 deploys the smart contract on the blockchain system 105 in FIG. 1 if the verification process in step 705 is successful. This step may be performed by smart contract deployment module 313 shown in FIG. 3. In some embodiments, the client device 101 may send the smart contract data to the blockchain system 105, and blockchain system 105 may receive the smart contract data, store and operate the smart contract. In some embodiments, the smart contract may contain the digital certificate, the signature, the message and the public key entered in step 704 which may be accessed by users who are using the blockchain by calling certain smart contract function or variable that transmits the digital certificate, the signature, the message or the public key.

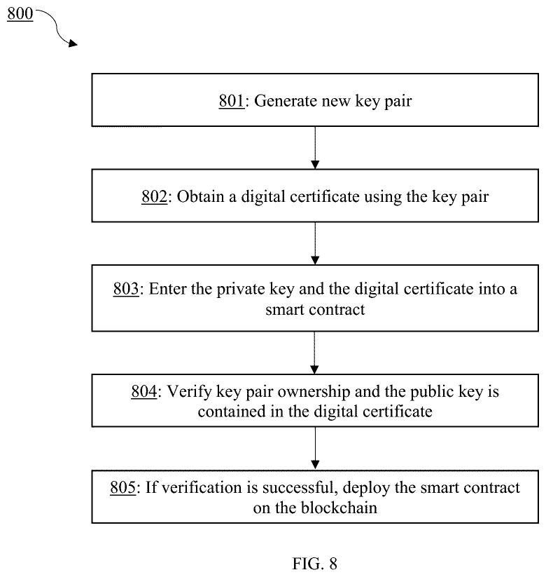

FIG. 8 illustrates a flow diagram of an example of a method 800 for authenticating a smart contract, according to some embodiments. The method 800 may be similar to method 700 except that the entity performing method 800 is willing to enter the entity's private key into a smart contract that the entity wishes to deploy. In some embodiments, method 800 may be performed by an entity that wishes to deploy a smart contract on a blockchain who may not already own a website. For example, an entity may be an individual who wishes to deploy a smart contract where their ownership of their smart contract can be authenticated. The method 800 may be implemented by one or more components of the system 300 of FIG. 3. The method 800 may be implemented by a system running on a computing device 200 shown in FIG. 2 and interconnected with other devices as shown in FIG. 1. The operations presented below are intended to be illustrative. Depending on the implementation, the method 800 may include additional, fewer, or alternative steps performed in various orders or in parallel.

At step 801, a client device 101 in FIG. 1 generates a new key pair consisting of a private key and a public key. This step may be performed by an entity using OpenSSL installed in a client device 101 by executing OpenSSL available commands.

At step 802, the entity obtains a new digital certificate using the key pair in step 801 from a certificate authority (CA). In some embodiments, obtaining a digital certificate includes: (i) the entity using client device 101 with OpenSSL generating a request, such as certificate signature request (CSR), containing contents such as public key for which the certificate should be issued and identifying information (such as website address, personal ID, name, organization name, country) of the entity; (ii) client device 101 sending the request to a certificate authority (CA) and the certificate authority (CA) receiving the request via digital certification server 303 depicted in FIG. 1 and verifying the contents in the request; and (iii) certificate authority (CA) issuing a new digital certificate signed by the certificate authority (CA) and sending the digital certificate back to the client device 101. The digital certificate may be transmitted by the digital certificate creator module 308 depicted in FIG. 3.

At step 803, an entity using client device 101 enters the private key from the key pair and the digital certificate into a smart contract. This step may be implemented by the smart contract deployment module 313 depicted in FIG. 3. In some embodiments, the smart contract may be programming source code that has yet to be compiled and the digital certificate, and the private key can be entered inside the constructor function in the source code. In some embodiments, the smart contract may already be compiled but yet to be deployed on a blockchain. The private key may be entered in the smart contract but not permanently stored in the smart contract which renders the private key inaccessible from the smart contract once it is deployed on a blockchain.

At step 804, the client device 101 verifies that the entity is the owner of the key pair in step 801 and verifies that the public key of the key pair is contained in the digital certificate. In some embodiments, this step may be performed using OpenSSL. In some embodiments, this step may be performed using smart contract function. In some embodiments, step 804 may include: (i) extracting the public key from the private key; (ii) extracting public key from the digital certificate; and (iii) determining if the public key in (i) matches the public key in (ii). If it is a match, this may verify that the entity owns the existing key pair and the website digital certificate.

At step 805, the client device 101 deploys the smart contract on the blockchain system 105 in FIG. 1, if the verification process in step 804 is successful. This step may be performed by smart contract deployment module 313 shown in FIG. 3. In some embodiments, the client device 101 may send the smart contract data to the blockchain system 105, and blockchain system 105 may receive the smart contract data, store and operate the smart contract. In some embodiments, the smart contract may contain the digital certificate entered in step 803 which may be accessed by users who are using the blockchain by calling certain smart contract function or variable that transmits the digital certificate.

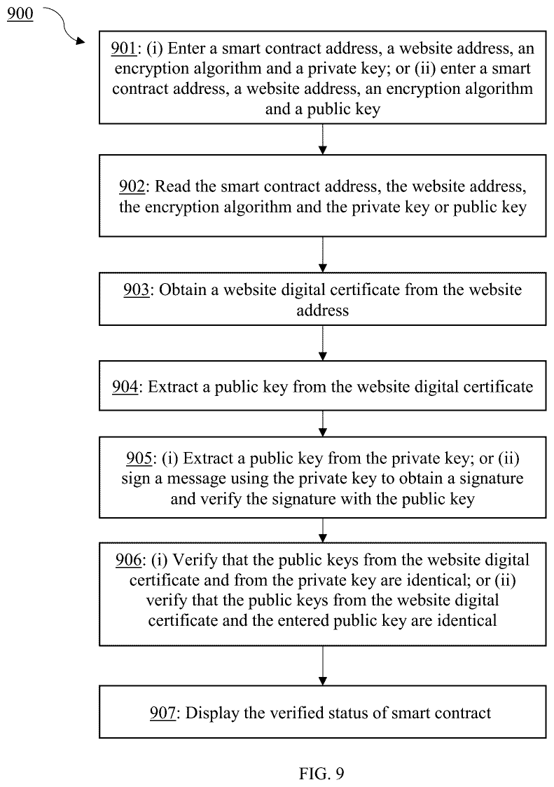

FIG. 9 illustrates a flow diagram of an example of a method 900 for verifying the ownership of a smart contract, according to some embodiments. In some embodiments, method 900 may be performed by an entity that owns a website and wishes to verify the entity's smart contract that is already deployed on a blockchain. For example, an entity may be an enterprise that owns an existing website that wishes to verify their ownership of a smart contract that they deployed. The method 900 may be implemented by a system running on a computing device 200 shown in FIG. 2 and interconnected with other devices as shown in FIG. 1. The method 900 may be implemented by one or more components of the system 400 of FIG. 4. The operations presented below are intended to be illustrative. Depending on the implementation, the method 900 may include additional, fewer, or alternative steps performed in various orders or in parallel.

At step 901, an entity using client device 101 shown in FIG. 1: (i) enters a smart contract address, a website address, an encryption algorithm and a private key; or (ii) enters a smart contract address, a website address, an encryption algorithm and a public key. In some embodiments, the encryption algorithm may be the RSA algorithm and the private key may be generated using the RSA algorithm. In some embodiments, entity may prefer to safeguard their private key, thus reluctant to enter their private key. Thus, the entity may choose step 901 (ii) by entering their public key. Then, the client device 101 sends the data in step 901 (i) or (ii) to a block explorer server 106 depicted in FIG. 1.

At step 902, the block explorer server 106 receives the smart contract address, the website address, the encryption algorithm and the private or public key entered in step 901 from client device 101. This step 902 may be performed by the verification system 404 in FIG. 4. In some embodiments, the encryption algorithm may be the RSA algorithm and the private or public key may be generated using the RSA algorithm.

At step 903, the block explorer server 106 requests a website digital certificate of the website with the website address given in step 902 from web server 102 shown in FIG. 1. The web server 102 then transmits the website digital certificate to the block explorer 106. In some embodiments, this digital certificate may be an SSL/TLS certificate. The digital certificate may be transmitted by the digital certificate module 409 illustrated in FIG. 4.

At step 904, the block explorer server 106 extracts a public key from the website digital certificate. In some embodiments, the public key may be based on the RSA algorithm. Step 904 may be performed by cryptography module 406 shown in FIG. 4. In some embodiments, step 904 can be performed using OpenSSL.

At step 905, the block explorer server 106 either: (i) extracts a public key from the private key that was received from client device 101, if step 901 (i) was performed earlier; or (ii) requests the entity at client device 101 to sign a message using the entity's private key to obtain a signature, and verifying the signature, if step 901 (ii) was performed. For step 905 (ii), the private key was not sent to block explorer server 106 in step 901 (ii). Thus, at step 905 (ii), the block explorer sends a message to the client device 101 and requests the entity using client device 101 to sign the message using the entity's private key to produce a signature. In some embodiments, step 905 (ii) of signing a message may include: (a) creating a message digest from a message using a hash function, e.g., where the hash function includes SHA-256; and (b) creating a signature by encrypting the message digest using the private key. After producing the signature, client device 101 sends the signature back to block explorer 106 and the block explorer 106 receives the signature and verifies the message. In some embodiments, step 905 (ii) of verifying a message may include: (a) obtaining the message digest by decrypting the signature using the public key; (b) creating a message digest from the message that was sent to client device 101 using a hash function where the hash function can be using SHA-256; and (c) comparing the message digest obtained from (a) with the message digest from (b) and if the two digests match, it may indicate that the signature is verified. Step 905 (i) may be performed by cryptography module 406 shown in FIG. 4. In some embodiments, step 905 (i) and (ii) may be performed using OpenSSL. The end result of step 905 may be block explorer 106 obtains either: (i) the public key, if 905 (i) was performed, or (ii) the verified message, if step 905 (ii) was performed.

At step 906, the block explorer 106 either: (i) verifies that the public key from the website digital certificate (obtained at step 904) and the public key from the private key (obtained at step 905 (i)) are identical, if step 905 (i) was performed; or (ii) verifies that the public key from the website digital certificate (obtained at step 904) and the public key used in verifying the message at step 905 (ii) are identical, if step 905 (ii) was performed. If the public keys are identical in (i) or (ii), the smart contract is verified.

At step 907, block explorer 106 displays the verified status of the smart contract. Step 907 may be performed by smart contract display module 407 depicted in FIG. 4. In some embodiments, a visual cue similar to the blue checkmark implemented by Twitter may be used to indicate that the smart contract was verified. In some embodiments, the website digital certificate may be displayed and/or downloadable. In some embodiments, step 907 may include displaying the website address.

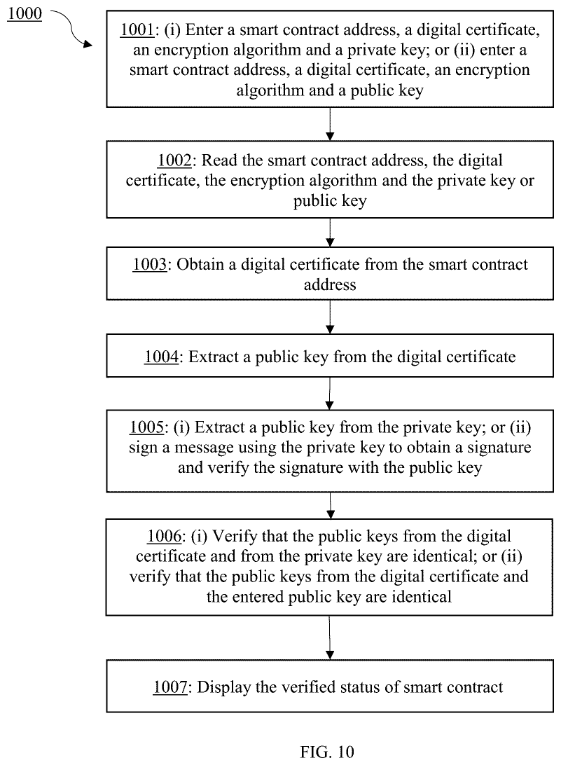

FIG. 10 illustrates a flow diagram of an example of a method 1000 for verifying the ownership of a smart contract, according to some embodiments. In some embodiments, method 1000 may be performed by an entity that does not own a website and wishes to verify the entity's smart contract that is already deployed on a blockchain. For example, an entity may be an individual that does not own a website that wishes to verify their ownership of a smart contract that they deployed. The method 1000 may be implemented by one or more components of the system 400 of FIG. 4. The method 1000 may be implemented by a system running on a computing device 200 shown in FIG. 2 and interconnected with other devices as shown in FIG. 1. The operations presented below are intended to be illustrative. Depending on the implementation, the method 1000 may include additional, fewer, or alternative steps performed in various orders or in parallel.

At step 1001, an entity using client device 101 shown in FIG. 1: (i) enters a smart contract address, a digital certificate, an encryption algorithm and a private key; or (ii) enters a smart contract address, a digital certificate, an encryption algorithm and a public key. In some embodiments, the encryption algorithm may be the RSA algorithm and the public and private key may be generated using the RSA algorithm. In some embodiments, step 1001 may be performed with input module 405 depicted in FIG. 4. In some embodiments, the entity may prefer to safeguard their private key, and thus would be reluctant to enter their private key. As a result, the entity may choose step 1001 (ii) by entering their public key. Then, the client device 101 sends the data in step 1001 (i) or (ii) to a block explorer server 106 depicted in FIG. 1.

At step 1002, the block explorer server 106 receives the smart contract address, the digital certificate, the encryption algorithm and the private or public key entered in step 1001 from client device 106. This step 1002 may be performed by the verification system 404 in FIG. 4. In some embodiments, the encryption algorithm may be the RSA algorithm and the private or public key may be generated using the RSA algorithm.

At step 1003, the block explorer server 106 requests a digital certificate of the smart contract from blockchain system 105 shown in FIG. 1 via the smart contract address given in step 1002. The blockchain system 105 then transmits the digital certificate contained in the smart contract to block explorer 106. In some embodiments, this digital certificate may be an SSL/TLS certificate. The digital certificate may be transmitted by the cryptographic module 403 illustrated in FIG. 4.

At step 1004, the block explorer server 106 extracts a public key from the digital certificate. In some embodiments, the public key may be based on the RSA algorithm. Step 1004 may be performed by cryptographic module 406 in verification system 404 shown in FIG. 4. In some embodiments, step 1004 may be performed using OpenSSL.

At step 1005, the block explorer server 106 either: (i) extracts a public key from the private key that was received from client device 101, if step 1001 (i) was performed earlier; or (ii) requests the entity at client device 101 to sign a message using the entity's private key to obtain a signature, and verifying the signature, if step 1001 (ii) was performed. For step 1005 (ii), the private key was not sent to block explorer server 106 in step 1001 (ii). Thus, at step 1005 (ii), the block explorer sends a message to the client device 101 and requests the entity using client device 101 to sign the message using the entity's private key to produce a signature. In some embodiments, step 1005 (ii) of signing a message may include: (a) creating a message digest from a message using a hash function, e.g., where the hash function includes SHA-256; and (b) creating a signature by encrypting the message digest using the private key. After producing the signature, client device 101 sends the signature back to block explorer 106 and the block explorer 106 receives the signature and verifies the message. In some embodiments, step 1005 (ii) of verifying a message may include: (a) obtaining the message digest by decrypting the signature using the public key; (b) creating a message digest from the message that was sent to client device 101 using a hash function where the hash function can be using SHA-256; and (c) comparing the message digest obtained from (a) with the message digest from (b) and if the two digests match, it may indicate that the signature is verified. Step 1005 (i) may be performed by cryptography module 406 shown in FIG. 4. In some embodiments, step 1005 (i) and (ii) may be performed using OpenSSL. The end result of step 1005 may be block explorer 106 obtains either: (i) the public key, if 1005 (i) was performed, or (ii) the verified message, if step 1005 (ii) was performed.

At step 1006, the block explorer 106 either: (i) verifies that the public key from the digital certificate (obtained at step 1004) and the public key from the private key (obtained at step 1005 (i)) are identical, if step 1005 (i) was performed; or (ii) verifies that the public key from the digital certificate (obtained at step 1004) and the public key used in verifying the message at step 1005 (ii) are identical, if step 1005 (ii) was performed. If the public keys are identical in (i) or (ii), the smart contract is verified.

At step 1007, block explorer 106 displays the verified status of the smart contract. Step 1007 may be performed by smart contract display module 407 depicted in FIG. 4. In some embodiments, a visual cue similar to the blue checkmark implemented by Twitter may be used to indicate that the smart contract was verified. In some embodiments, the digital certificate may be displayed and/or downloadable.

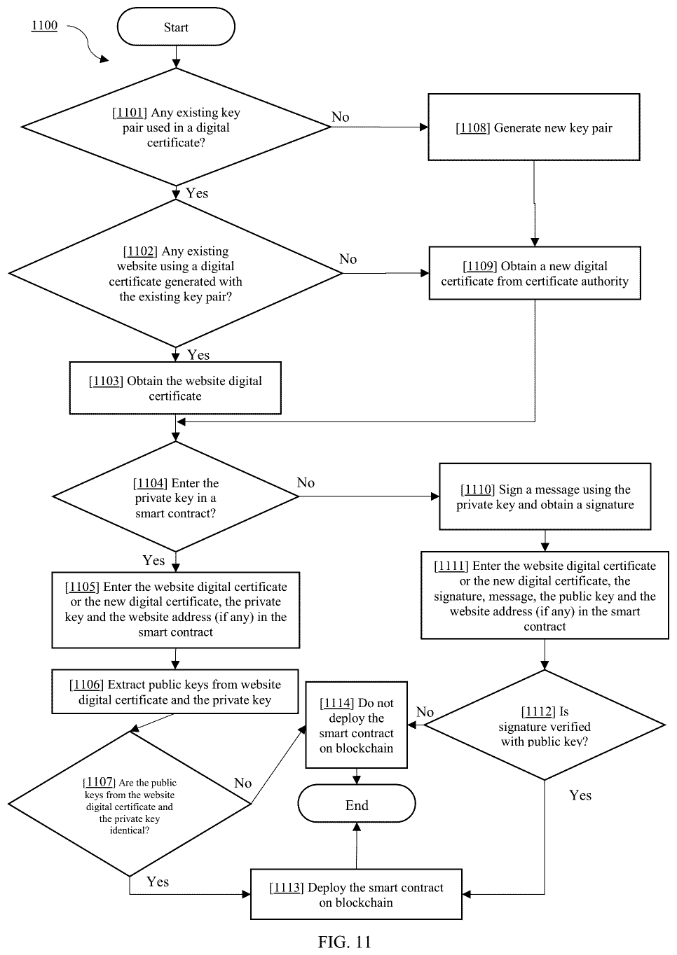

FIG. 11 illustrates a flowchart of an example of a method 1100 for authenticating a smart contract, according to some embodiments. The method 1100 may be implemented by a system running on a computing device 200 shown in FIG. 2 and interconnected with other devices as shown in FIG. 1. The method 1100 may be initiated by an entity using client device 101 shown in FIG. 1 that wishes to authenticate and deploy their smart contract. The method 1100 may be implemented by one or more components of the system 300 of FIG. 3. The operations presented below are intended to be illustrative. Depending on the implementation, the method 1100 may include additional, fewer, or alternative steps performed in various orders or in parallel.

At step 1101, an entity using client device 101 shown in FIG. 1 determines if they own an existing key pair that was used in creating an existing digital certificate, such as one created for a website. In some embodiments, the existing key pair may be based on the RSA algorithm. If step 1101 determines that an existing key pair is available (step 1101 “yes” branch), the method 1100 may continue to step 1102 to further determine if there is any existing website using a digital certificate generated with the existing key pair.

At step 1102, if entity determines there is an existing website using a digital certificate generated with the existing key pair (step 1102, “yes” branch), the method 1100 may continue to step 1103.

At step 1103, client device 101 requests for the website digital certificate from web server 102 shown in FIG. 1 and web server 102 transmits the digital certificate back to client device 101. Step 1103 may be performed by entity with a client device 101 installed with OpenSSL. In some embodiment, step 1103 may be obtaining an SSL/TLS digital certificate.

At step 1101, if entity determines that there is no existing key pair (step 1101, “no” branch), the method 1100 may proceed to step 1108 to generate a new key pair. In some embodiments, key pair generation process in step 1108 may be performed by using OpenSSL using client device 101. In some embodiments, the key pair in step 1108 may be based on the RSA algorithm.

At step 1109, entity using client device 101 requests a new digital certificate by transmitting a certificate signing request (CSR) to a certificate authority (CA). The certificate authority (CA) then transmits the new digital certificate to client device 101 for entity. In some embodiments, the certificate authority (CA) may be digital certification server 103 in FIG. 1. In some embodiments, obtaining a new digital certificate from certificate authority (CA) may be performed by the components in cryptography system 301 and certification system 307 illustrated in FIG. 3. Step 1109 may then proceed to step 1104.

At step 1104, entity using client device 101 determines if they wish to enter the private key from the key pair in a smart contract that they wish to authenticate and deploy. If entity wishes to enter the private key (step 1104, “yes” branch), method 1100 proceeds to step 1105 where the entity either: (i) enters the website digital certificate (obtained in step 1103), the private key (obtained in step 1101) and the website address (obtained in step 1102) in the smart contract; or (ii) enters the new digital certificate (from step 1109) and the private key (from step 1108) in the smart contract.

At step 1106, the smart contract in client device 101 extracts the public keys from the website digital certificate and the private key using smart contract deployment module 313 in FIG. 3. In some embodiments, this public key extraction process may be performed by using OpenSSL.

At step 1107, the smart contract in client device 101 determines if the public keys from the website digital certificate and the private key are identical. If it is determined that the public keys are identical (step 1107 “yes” branch), the method 1100 may proceed to step 1113.

At step 1113, the smart contract in client device 101 deploys on the blockchain. The blockchain may be implemented by blockchain system 105 in FIG. 1. Step 1113 may be implemented via the smart contract deployment module 313 in smart contract development system 312 depicted in FIG. 3.

At step 1107, if smart contract determines that the public keys are not identical (step 1107, “no” branch), the method 1100 may proceed to step 1114. Step 1114 may include not deploying the smart contract on a blockchain and smart contract may display an error message on client device 101 to indicate to entity the error in deployment. Step 1107 may be implemented via the smart contract deployment module 313 in smart contract development system 312 depicted in FIG. 1.

If entity does not wish to enter the private key (step 1104 “no” branch), method 1100 proceeds to step 1110. Step 1110 may include signing a message using the private key and obtaining a signature. In some embodiments, step 1110 may be performed by using OpenSSL.

At step 1111, entity using client device 101 either: (i) enters the website digital certificate (obtained from step 1103), the signature and the message (obtained from step 1110), the public key from existing key pair (obtained from step 1101) and the website address in the smart contract; or (ii) entering the new digital certificate (obtained from step 1109), the signature and the message (obtained from step 1110), the public key from new key pair (obtained from step 1108) in the smart contract. Subsequently, the method 1100 may proceed to step 1112.

At step 1112, the smart contract in client device 101 determines if the signature was verified with the public key from the existing key pair (obtained from step 1101) or from the new key pair (obtained from step 1108). Step 1112 may be implemented via the smart contract deployment module 313 in smart contract development system 312 depicted in FIG. 3. If the signature was verified (step 1112, “yes” branch), the method 1100 may proceed to step 1113. At step 1113, client device 101 deploys the smart contract on the blockchain via the smart contract deployment module 313 in smart contract development system 312 depicted in FIG. 1. The blockchain may be implemented by blockchain system 105 in FIG. 1.

At step 1112, if the smart contract in client device 101 determines that the signature was not verified (step 1112, “no” branch), the method 1100 may proceed to step 1114.

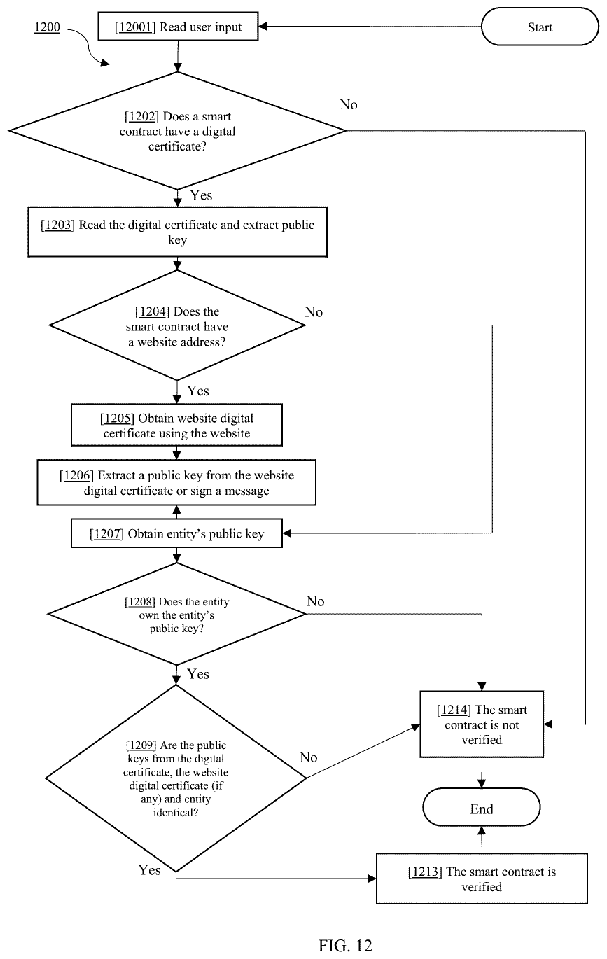

FIG. 12 illustrates a flowchart of an example of a method 1200 for verifying the ownership of a smart contract, according to some embodiments. The method 1200 may be implemented by one or more components of the system 400 of FIG. 4. The method 1200 may be implemented by a system running on a computing device 200 shown in FIG. 2 and interconnected with other devices as shown in FIG. 1. The method 1200 may be initiated by an entity using client device 101 shown in FIG. 1 that wishes to verify their smart contract. The operations presented below are intended to be illustrative. Depending on the implementation, the method 1200 may include additional, fewer, or alternative steps performed in various orders or in parallel.

At step 1201, an entity using client device 101 shown in FIG. 1 enters user inputs and sends the inputs to a block explorer server 106 as shown in FIG. 1. The block explorer 106 reads the user input. In some embodiments, the user input may be data such as smart contract address, wallet address, website address, an encryption algorithm and a private key or public key. In some embodiments, the entity may prefer to safeguard their private key, and thus would be reluctant to enter their private key. As a result, the entity may choose to enter their public key. In some embodiments, the encryption algorithm may be the RSA algorithm and the public and private key may be generated using the RSA algorithm. In some embodiments, step 1201 may be performed with input module 405 in depicted in FIG. 4.

At step 1202, the block explorer 106 determines if the smart contract contains a digital certificate. In some embodiments, the digital certificate may be in X.509 format. In some embodiments, the determination of step 1202 may be performed by a software library that could call certain functions in the smart contract to obtain the digital certificate.

If step 1202 determines that digital certificate is not available (step 1202, “no” branch), the method 1200 may proceed to step 1214 where the smart contract may not be verified. In some embodiments, step 1214 may include displaying a visual cue indicating that the smart contract is not verified. In some embodiments, the block explorer 106 may send an error message to the client device 101 and client device 101 display the message to the entity indicating the smart contract is not verified.

If step 1202 determines that digital certificate is available (step 1202, “yes” branch), the method 1200 may continue to step 1203. Step 1203 may include the block explorer 106 reading the digital certificate and extracting the public key from the digital certificate.

At step 1204, the block explorer 106 determines if the smart contract includes a website address. If the smart contract contains no website address (step 1204, “no” branch), method 1200 may proceed to step 1207.

If step 1204 determines the smart contract contains a website address (step 1204, “yes” branch), method 1200 may proceed to step 1205.

At step 1205, the block explorer 106 requests for a website digital certificate using the website address from web server 106 as depicted in FIG. 1. Then, the web server 106 sends the website digital certificate to block explorer 106.

At step 1206, the block explorer 106 extracts a public key from the website digital certificate. In some embodiments, this extraction process may be performed using OpenSSL.

At step 1207, the block explorer 106 obtains the public key of the entity either by: (i) extracting the public key from the private key, if private key was provided in user input in step 1201; or (ii) providing a message to the entity to produce a signature using their private key if entity did not provide private key as user input in 1201, and verifying that the signature what signed using the private key. In some embodiments, step 1207 may be performed using OpenSSL.

At step 1208, the block explorer 106 determines if the entity is the owner of the public key obtained in step 1207. If step 1208 determines that the entity does not own the public key (step 1208, “no” branch), the method 1200 may proceed to step 1214 that may indicate the smart contract is not verified. If step 1208 determines that the entity owns the public key (step 1208, “yes” branch), the method 1200 may proceed to step 1209.

At step 1209, the block explorer 106 determines if the public keys from the website digital certificate and the entity are identical. Step 1209 may determine either: (i) the public keys from the digital certificate, the website digital certificate and the entity are identical; or (ii) the public keys from the digital certificate and the entity are identical, if website address and website digital certificate are absent in method 1200.

If step 1209 determines that the public keys are identical (step 1209, “yes” branch), the method 1200 may proceed to step 1213 that may indicate that the smart contract is verified. In some embodiments, step 1213 may be displaying a visual cue indicating that the smart contract is verified similar to the blue checkmark implemented by Twitter. In some embodiments, step 1213 may include displaying the website address, if the digital certificate was obtained from the website address in step 1205.

If step 1209 determines that the public keys are not identical (step 1209, “no” branch), the method 1200 may proceed to step 1214 that may indicate that the smart contract is not verified.

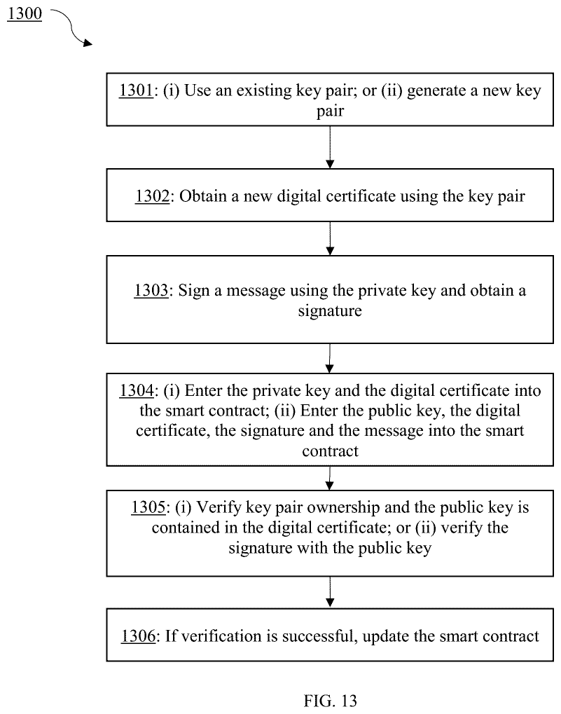

FIG. 13 illustrates a flow diagram of an example of a method 1300 for re-authenticating smart contract, according to some embodiments. In some embodiments, method 1300 may be implemented to replace expired digital certificates in existing smart contracts deployed on blockchains. The method 1300 may be implemented by one or more components of the system 300 of FIG. 3. The method 1300 may be implemented by a system running on a computing device 200 shown in FIG. 2 and interconnected with other devices as shown in FIG. 1. The operations presented below are intended to be illustrative. Depending on the implementation, the method 1300 may include additional, fewer, or alternative steps performed in various orders or in parallel.

At step 1301, an entity that owns an existing smart contract using client device 101 shown in FIG. 1 either: (i) reuses the same existing key pair that was previously used to authenticate the smart contract; or (ii) generates a new key pair. New key pair generation may be performed using OpenSSL installed in client device 101.

At step 1302, the entity obtains a new digital certificate using the key pair in step 1301 from a certificate authority (CA). In some embodiments, obtaining a digital certificate includes: (i) the entity using client device 101 using OpenSSL generating a request, such as certificate signature request (CSR), containing contents such as public key for which the certificate should be issued and identifying information (such as website address, personal ID, name, organization name, country) of the entity; (ii) client device 101 sending the request to a certificate authority (CA) and the certificate authority (CA) receiving the request via digital certification server 103 depicted in FIG. 1 and verifying the contents in the request; and (iii) certificate authority (CA) issuing a new digital certificate signed by the certificate authority (CA) and sending the digital certificate back to the client device 101. The digital certificate may be transmitted by the digital certificate creator module 308 in the certification system 307 in system 300 depicted in FIG. 3.

In some embodiments, step 1302 may include obtaining an updated website digital certificate from an existing website. In some embodiments, obtaining an updated website digital certificate includes: (i) the entity using client device 101 requesting for the website digital certificate from a website via web server 102 shown in FIG. 1 (ii) the web server 102 transmitting the website digital certificate back to the client device 101.

The website digital certificate can be transmitted by the digital certificate module 306 in the website system 305 depicted in FIG. 3.

At step 1303, entity using client device 101 signs a message using their private key and obtain a signature without needing to enter the private key into the smart contract. In some embodiments, the entity may prefer to safeguard their private key, thus reluctant to enter the private key into the smart contract. In some embodiments, step 1303 may be comprising: (a) creating a message digest from a message using a hash function (e.g., SHA-256); and (b) creating a signature by encrypting the message digest using the private key. Step 1303 may be performed by key pair management module 302 in system 300 in FIG. 3.

At step 1304, the entity using client device 101 includes either: (i) the entity entering the private key, the digital certificate into the smart contract; or (ii) the entity entering the public key, the digital certificate, the signature and the message (from step 1303) into the smart contract. In some embodiments, if an existing website address is already stored in the smart contract or if the digital certificate was retrieved from a website, the website address may be entered in (i) and (ii).

Step 1305 may be implemented by client device 101 and by blockchain system 105 shown in FIG. 1. At step 1305, client device 101 and blockchain system 105 either: (i) verifies key pair ownership and that the public key is contained in the digital certificate, if step 1304 (i) was performed; or (ii) verifies that the signature with the public key, if step 1304 (ii) was performed.

In some embodiments, step 1305 (i) may include: (a) extracting the public key from the private key; (b) extracting public key from the digital certificate; and (c) determining if the public key in (a) matches the public key in (b). If the public keys match, this may verify that the entity owns the key pair and the digital certificate.

In some embodiments, step 1305 (ii) may include: (a) obtaining the message digest by decrypting the signature using the public key; (b) creating a new message digest from the message from step 1304 using a hash function (e.g., SHA-256); and (c) comparing the message digest obtained from (a) with the new message digest from (b). If the two digests match, it may indicate that the signature is verified. A verified signature may prove that the entity owns the key pair that was used to create the digital certificate.

At step 1306, the smart contract deployment module 313 shown in FIG. 3 updates the smart contract on the blockchain if the verification process in step 1305 is successful. In some embodiments, the updating process may include updating existing data with new data (e.g., data entered in step 1304).

What is claimed is:

1. A computer-implemented method for authenticating smart contracts, the method comprising:
obtaining an existing cryptographic key pair associated with a website digital certificate, the cryptographic key pair comprising a public key and a private key;
generating a signature derived from signing a message using the private key of the existing cryptographic key pair;
storing the signature, the message, the public key, and a website address associated with the website digital certificate into a smart contract;
verifying that the signature was signed with the same cryptographic key pair associated with the website digital certificate; and
deploying the smart contract on a blockchain based on the verifying.

2. The method of claim 1, where the website digital certificate comprises a Secure Sockets Layer (SSL)/Transport Layer Security (TLS) digital certificate.

3. A computer-implemented method for verifying smart contracts comprising:
reading a first public key stored in a smart contract;
reading a website address stored in a smart contract;
reading a digital certificate based on the website address;
reading a second public key in the digital certificate; and
verifying that the first public key in the smart contract is the same as the second public key in the digital certificate.

4. The computer-implemented method of claim 3, where the digital certificate comprises a Secure Sockets Layer (SSL)/Transport Layer Security (TLS) digital certificate.

5. A computer-implemented method for authenticating smart contracts comprising:
obtaining a digital certificate;
verifying the digital certificate was signed with a private key associated with the digital certificate; and
deploying a smart contract on a blockchain based on the verifying the digital certificate was signed.

6. The method of claim 5, where:
the digital certificate is associated with a website, and
obtaining the digital certificate comprises obtaining the digital certificate using an existing cryptographic key pair used to obtain the digital certificate, the existing cryptographic key pair comprising the private key and a public key.

7. The method of claim 6, further comprising inserting the digital certificate, the existing cryptographic key pair, and a website address associated with the website in a smart contract.

8. The method of claim 5, where obtaining the digital certificate comprises:
generating a new pair of cryptographic keys, the new pair of cryptographic keys comprising the private key and a public key; and
requesting a digital certificate from a certificate authority based on the new pair of cryptographic keys.

9. The method of claim 8, inserting the digital certificate and the new pair of cryptographic keys in the smart contract.

10. The method of claim 5, where obtaining the digital certificate comprises:
generating a request for the digital certificate, the request comprising a public key and identifying information of an entity associated with the public key; and
receiving the digital certificate from a certificate authority.

11. The method of claim 10, where the request comprises a certificate signature request (CSR).

12. The method of claim 10, where the identifying information comprises at least one of a domain name, personal identifier, a name, an organization name, and a country.

13. A method for verifying the authenticity of a smart contract, the method comprising:
reading a first public key in the smart contract;
reading a digital certificate in the smart contract;
extracting a second public key in the digital certificate; and
verifying that the first public key and the second public key are identical.

14. The method of claim 13, further comprising displaying a verified status of the smart contract on a block explorer.

15. A method of updating a smart contract, further comprising:
generating a new pair of cryptographic keys, comprising a new public key and a new private key;
obtaining a new digital certificate using the new pair of cryptographic keys;
replacing an old public key and an old digital certificate with the new public key and the new digital certificate in the smart contract on a blockchain;
verifying that the new digital certificate was signed with the new pair of cryptographic keys; and
updating the smart contract.

16. The method of claim 1, wherein the smart contract has not been compiled and not yet been deployed on a blockchain.

17. The method of claim 1, wherein the smart contract has been compiled and not yet been deployed on a blockchain.
